(19) United States
(12) Patent Application Publication
(10) Pub. No.: US 2017/0046890 A1
(43) Pub. Date: Feb. 16, 2017

(54) PHYSICAL ACCESS MANAGEMENT USING A DOMAIN CONTROLLER

(71) Applicant: Schweitzer Engineering Laboratories, Inc., Pullman, WA (US)

(72) Inventors: Rhett Smith, Kuna, ID (US); George W. Masters, Moscow, ID (US)

(21) Appl. No.: 14/823,210

(22) Filed: Aug. 11, 2015

(51) Int. Cl. G07C 9/00

(52) U.S. Cl. CPC G07C 9/00031

(57) ABSTRACT

Systems and methods are disclosed for managing physical access to an access-controlled area using a domain controller. In certain embodiments, physical access attribute and/or credential information may be managed as part of a user entry in a directory service managed by the domain controller. Using this information, the domain controller and/or a communicatively coupled access control system may perform physical access control determinations based on physical access control requests received from a user wishing to gain physical access to an access-controlled area.

### FEDERALLY SPONSORED RESEARCH OR DEVELOPMENT

This invention was made with U.S. Government support under Contract No.: DOE-OE0000680. The U.S. Government may have certain rights in this invention.

### TECHNICAL FIELD

This disclosure relates to systems and methods for managing physical access to an access-controlled area of a distributed site of an electric power delivery system and, more particularly, to systems and methods for managing physical access to an access-controlled area using a domain controller.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates an example of a physical access management architecture consistent with embodiments disclosed herein.

FIG. 2 illustrates a diagram showing an example of a physical access management process consistent with embodiments disclosed herein.

FIG. 3 illustrates an example of domain controller directory service user entries including physical access attribute information consistent with embodiments disclosed herein.

FIG. 4 illustrates a method of managing physical access to an access-controlled area consistent with embodiments disclosed herein.

FIG. 5 illustrates a functional block diagram of a domain controller consistent with embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Electrical power generation and delivery systems are designed to generate, transmit, and distribute electrical energy to loads. Electrical power generation and delivery systems may include a variety of equipment, such as electrical generators, electrical motors, power transformers, power transmission and distribution lines, circuit breakers, switches, buses, transmission and/or feeder lines, voltage regulators, capacitor banks, and/or the like. Such equipment may be monitored, controlled, automated, and/or protected using intelligent electronic devices (“IEDs”) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (“PLCs”), programmable automation controllers, input and output modules, governors, exciters, statcom controllers, access control systems, SVC controllers, OLTC controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

Certain equipment associated with an electrical power generation and delivery system may be distributed in one or more sites and/or locations. For example, a variety of equipment (e.g., IEDs, network equipment, and/or the like) may be associated with a distribution substation location of an electric power delivery system. In some circumstances, distributed sites of an electrical power generation and delivery system may be located in relatively remote and/or infrequently accessed locations. For example, certain distributed sites may be accessed infrequently by individuals performing maintenance, diagnostic, and/or repair activities on equipment associated with the sites (e.g., utility and/or other service personnel).

To ensure the physical security of a distributed site and/or associated equipment, a distributed site may include one or more access control devices including, for example, locks (e.g., electromagnetic, mechanical, and/or solenoid locks), tamper protection devices, security-hardened buildings, enclosures, and/or utility boxes, alarm systems, and/or the like. An access control system in communication with the one or more access control devices may be configured to allow personnel wishing to access the distributed site to authenticate their identity and/or their rights to physically access an associated access-controlled area of the distributed site and/or associated equipment. Based on a successful authentication, the access control system may issue one or more control signals to associated physical access control devices configured to allow the personnel physical access to the access-controlled area of the distributed site and/or associated equipment (e.g., by issuing a control signal configured to disengage a solenoid lock, an alarm system, and/or the like). In some embodiments, the access control system and/or associated devices may establish a secure access-controlled boundary associated with the distributed site.

A variety of computer systems may be included in and/or brought within an access-controlled area. For example, in some embodiments, equipment included in an access-controlled area associated with an electrical power generation and delivery system, including certain IEDs, may comprise one or more computer systems. In further embodiments, personnel entering an access-controlled area may bring a laptop computer system and/or other computing device within the access-controlled area.

In certain embodiments, computer systems included and/or brought within an access-controlled area may be managed by a domain controller computer system. Among other things, the domain controller may manage access to a variety of computing resources associated with one or more computing domains. For example, the domain controller may respond to computing domain security authentication requests from one or more client computer systems associated with a user, may authenticate and/or otherwise authorize access to domain computing resources, and/or assign and/or enforce access and/or security policies associated with domain resources. In certain embodiments, to access computing resources managed by a domain controller, a user may enter user domain authentication information and/or credentials into an associated computing system that may be verified by the domain controller in connection with domain resource access authentication requests.

Physical access control to an access-controlled area, including management of information used in connection with access control decisions, may be managed by an access control system separate from the domain controller. Such a configuration, however, may result in increased costs associated with maintaining and managing separate physical access control and domain controller systems. Consistent with embodiments disclosed herein, a domain controller may be used in connection with managing physical access to an access-controlled area. In certain embodiments, physical access attribute and/or credential information may be managed as part of a user entry in a directory service managed by the domain controller. Using this information, the domain controller and/or a communicatively coupled access control system may perform physical access control determinations based on physical access control requests received from a user wishing to gain physical access to an access-controlled area.

Several aspects of the embodiments described herein are illustrated as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (“ASIC”), PAL, PLA, PLD, field programmable gate array (“FPGA”), or any other customizable or programmable device.

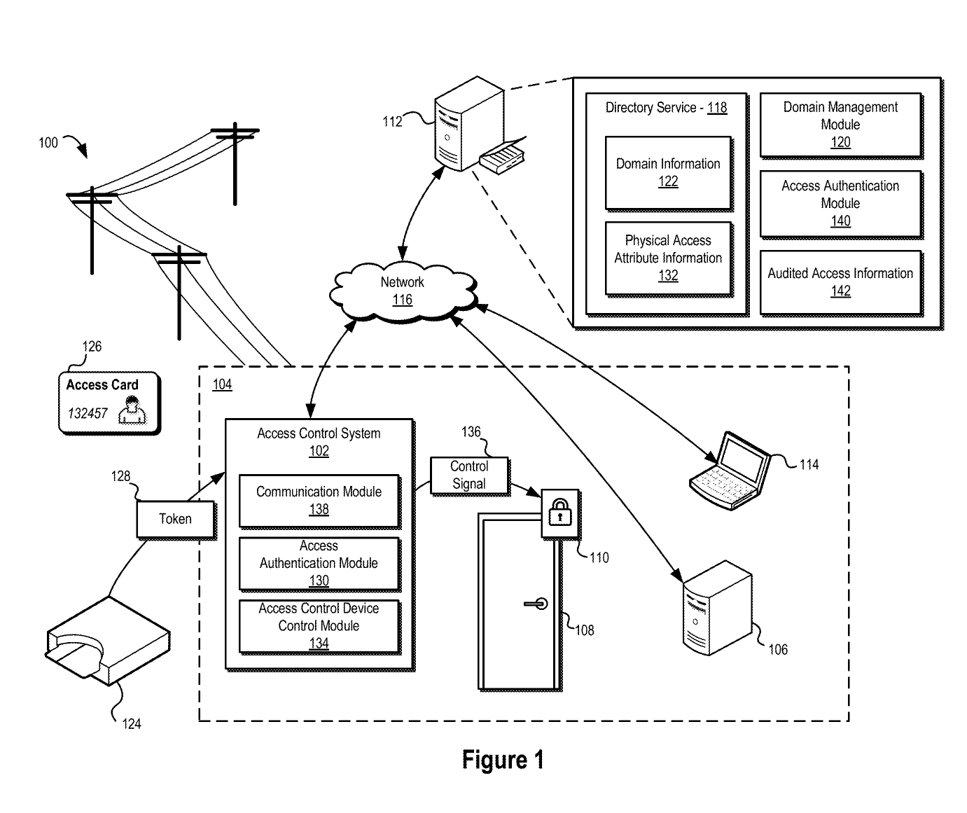

FIG. 1 illustrates an example of a physical access management 100 architecture consistent with embodiments disclosed herein. In certain embodiments, an access control system 102 may be associated with an access-controlled area 104 of a distributed site of an electric power generation and delivery system. Consistent with embodiments disclosed herein, the access control system 102 may be configured to manage physical access to the access-controlled area 104 and/or various equipment and/or computing systems 106 located within the access-controlled area 104. Although illustrated in connection with an access-controlled area 104 of a distributed site of an electric power generation and delivery system, it will be appreciated that embodiments of the disclosed systems and methods may be utilized in connection with a variety of access-controlled areas.

The access-controlled area 104 may include a variety of equipment associated with the electric power generation and delivery system including, for example, one or more IEDs, network communication equipment, electrical generators, electrical motors, power transformers, power transmission and distribution lines, circuit breakers, switches, buses, transmission and/or feeder lines, voltage regulators, capacitor banks, computer systems 106, and/or the like. In certain embodiments, the access-controlled area 104 may comprise a subset of equipment associated with a distributed location of an electric power generation and/or delivery system (e.g., a portion of a distribution substation). For example, in some embodiments, the access-controlled area 104 may comprise a distribution substation of an electric power delivery system. In further embodiments, the access-controlled area 104 may comprise a panel and/or utility box housing equipment associated with an electrical power generation and/or delivery system.

Physical access to the access-controlled area 104 and/or equipment associated with the same may be facilitated via one or more access points 108. As illustrated, the access point 108 may comprise a door to a building associated with the access-controlled area 104. In further embodiments, the access point 108 may include one or more panels and/or boxes facilitating access to equipment housed therein. In yet further embodiments, the access point 108 may be associated with a particular piece of equipment (e.g., an IED or the like) within the access-controlled area 104. For example, the access point 108 may comprise an access panel to a particular piece of equipment within the access-controlled area 104.

Physical access by one or more users (not shown) to the access-controlled area 104 using the one or more access points 108 may be managed by one or more access control devices 110 associated with an access point 108. In certain embodiments, an access control device 110 may be controlled by the access control system 102 using to one or more control signals 136. The access control devices 110 may comprise one or more locks (e.g., electromagnetic, mechanical, and/or solenoid locks), alarm systems, and/or the like. For example, in certain embodiments, an access control device 110 may comprise an electronically actuated lock for a door.

Physical access to the access-controlled area 104 may be managed, at least in part, by an access control system 102 and/or a domain controller 112. The access control system 102, the domain controller 112 and/or other associated systems (e.g., computer systems 106, 114) may comprise any suitable computing system or combination of systems configured to implement embodiments of the systems and methods disclosed herein. In certain embodiments, the access control system 102, the domain controller 112, the computer systems 106, 114 and/or other associated systems may comprise at least one processor system configured to execute instructions stored on an associated non-transitory computer-readable storage medium. In some embodiments, the access control system 102, the domain controller 112, the computer systems 106, 114 and/or other associated systems may further comprise secure execution space configured to perform sensitive operations such as authentication credential validation, policy management and/or enforcement, and/or other aspects of the systems and methods disclosed herein. The access control system 102, the domain controller 112, the computer systems 106, 114 and/or other associated systems may further comprise software and/or hardware configured to enable electronic communication of information between the systems 102, 106, 112, 114 via one or more associated network connections (e.g., network 116).

The access control system 102, the domain controller 112, the computer systems 106, 114 and/or other associated systems may comprise a computing device executing one or more applications configured to implement embodiments of the systems and methods disclosed herein. In certain embodiments, the access control system 102, the domain controller 112, the computer systems 106, 114 and/or other associated systems may comprise a laptop computer system, a desktop computer system, an IED, a server computer system and/or any other computing system and/or device that may be utilized in connection with the disclosed systems and methods.

The various systems 102, 106, 112, 114 may communicate via one or more networks comprising any suitable number of networks and/or network connections. For example, as illustrated, the access control system 102 and/or computer systems 106, 114 may communicate with the domain controller 112 via network 116. The network connections may comprise a variety of network communication devices and/or channels and may utilize any suitable communication protocols and/or standards facilitating communication between the connected devices and systems. The network connections may comprise the Internet, a local area network, a virtual private network, and/or any other communication network utilizing one or more electronic communication technologies and/or standards (e.g., Ethernet or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may utilize IEEE's 802.11 standards (e.g., Wi-Fi®), Bluetooth®, ultra-wide band (“UWB”), Zigbee®, and/or any other suitable communication protocol(s).

In certain embodiments, certain computer systems (e.g., systems 106, 114) associated with the access-controlled area 104 may be managed by a domain controller 112. Among other things, the domain controller 112 may manage access by the systems 106, 114 to a variety of computing resources associated with one or more computing domains. For example, the domain controller 112 may receive computing domain security authentication requests from the computing systems 106, 114, may authenticate and/or otherwise authorize requested access to domain computing resources, and/or may assign and/or enforce access and/or security policies associated with domain resources.

In certain embodiments, the domain controller 112 may include a directory service 118 used in connection with domain management activities. The directory service 118 may comprise a database of domain information 122 that may include, among other things, one or more entries associated with domain users. The user entries may comprise information identifying a user, user domain login information (e.g., passwords and/or the like), and/or information relating to access rights and or roles within computing domains associated with the user. The directory service 118 may further include one or more executable module(s) configured to service access requests and maintain the database.

In some embodiments, certain domain management and/or domain resource management activities may be performed by a domain management module 120 executing on the domain controller 112 utilizing the domain information 122 managed by the directory service 118. As an example, when a user logs into a computer system that is part of an associated computing domain (e.g., computer system 106, 114), the domain management module 120 and/or the directory service 118 may authenticate a password provided by the user in connection with the login process and determine associated access rights to domain resources (e.g., determine whether the user is a system administrator and has rights to access administrator resources and/or the like). In some embodiments, the domain authentication process may utilize the domain information 122 included in the directory service 118. Although illustrated as a separate module, it will be appreciated that in certain embodiments, the domain management module 120 may be a part of the directory service 118.

To gain physical access to the access-controlled site 104, a user may interact with one or more physical access control interfaces 124 (e.g., keypads, buttons, biometric scanners, badge and/or card readers, and/or the like) in communication with the access control system 102. In some embodiments, the physical access control interface 124 may comprise a card reader configured to read information stored on an access card 126 presented by a user. In further embodiments, the physical access control interface 124 may comprise a touchscreen, a keyboard, a mouse, a track pad, and/or any other suitable interface associated with the access control system 102. In yet further embodiments, the interface 124 may comprise a physical key and/or electronic 10-digit key pad (e.g., a keypad displayed on a touchscreen interface).

Using the physical access control interface 124, a user may enter authentication credentials for authenticating their rights to physically access the access-controlled area 104. For example, as illustrated, a user may present an access card 126 to a physical access control interface 124 comprising a card reader. Authentication credentials stored on the card 126 such as a token 128 may be read from the access card 126 and communicated to the communicatively coupled access control system 102 for use in connection with a physical access authentication determination, as discussed in more detail below.

In other embodiments, a user may provide the access control system 102 with authentication credentials such as a personal identification number (“PIN”) or the like via a keypad interface. In further embodiments, authentication credentials provided to the access control system 102 may comprise any type of numeric (e.g., a PIN), alphanumeric, symbolic, biometric sensor input, information received from a security key or card in communication with the interface (e.g., using a near field communication (“NFC”) standard), and/or the like. Although embodiments disclosed herein are discussed in the context of using a token 128 stored on an access card 126 read by a physical access control interface 124 comprising a card reader, it will be appreciated that a variety of types of authentication credentials and associated physical access control interfaces may be used in connection with the disclosed embodiments.

After receiving the token 128, the access control system 102 may initiate a physical access authentication process using a control system access authentication module 130 executing thereon to determine whether the user providing the access card 126 has rights to physically access the access-controlled area 104. Consistent with embodiments disclosed herein, the access control system 102 may communicate with the domain controller 112 using a communication module 138 to access physical access attribute information 132 managed by the directory service 118. For example, in some embodiments, a database associated with the directory service 118 may include physical access attribute information 132 as part of an entry associated with managed domain users. Although illustrated as being separate, it will be appreciated that in certain embodiments, domain information 122 and physical access attribute information 132 may be included in a single database storing domain and physical access information in entries associated with various domain users.

The authentication module 130 may comprise software and/or hardware configured to authenticate the validity of the authentication credentials (e.g., token 128) provided to the physical access control system 102 and/or determine whether a user associated with the credentials has current rights to physically access the access-controlled area 104. The access authentication module 130 may further interact with an access control device control module 134 executing on the physical access control system 102 in connection with issuing one or more responses and/or control signals 136 to access control devices 110 configured to effectuate access control decisions.

In connection with the physical access authentication process, the authentication module 130 may compare the received credentials and/or token 128 with the physical access attribute information 132 managed by the directory service 118 of the domain controller 112 to determine if the credentials and/or token 128 are associated with a user having current access rights to the access-controlled area 104. If the credentials and/or token 128 are associated with a user having current access rights, the access control system 102 may issue one or more control signals 136 to an access control device 110 associated with an access point 108 of the access-controlled area 104. In certain embodiments, the control signal 124 may actuate a lock associated with the access point 108, may disable an alarm system associated with the access point 108, and/or the like. In further embodiments, a response indicating a successful authentication of the authentication credentials may be communicated from the access control system 102 to an associated interface 124 and/or the domain controller 112. In some embodiments, if the credentials and/or token 128 are not associated with a user having current access rights, the access control system 102 may issue one or more control signals 136 configured to prevent and/or otherwise disable physical access to the access-controlled area 104.

The domain controller 112 may, alternatively and/or in conjunction with the access control system 102, perform certain aspects of the physical access authentication process. For example, in some embodiments, the access control system 102 may communicate the authentication credentials including the token 128 along with an associated authentication request to the domain controller 112. Upon receipt of the credentials and the request, the domain controller 112 may perform a physical access authentication determination using an access authentication module 140 executing thereon. For example, in some embodiments, the domain controller 112 may compare the received credentials and/or token 128 with the physical access attribute information 132 managed by the directory service 118 to determine if the credentials and/or token 128 are associated with a user having current physical access rights to the access-controlled area 104. Based on the results of the determination, the domain controller 112 may communicate a response to the access control system 102 indicating whether the credentials and/or token 128 were authenticated by the service. In response, the access control system 102 may issue one or more control signals 136 configured to effectuate the access control decision.

In certain embodiments, the access control system 102 and/or the domain controller 112 may implement multi-factor authentication processes (e.g., a two-factor authentication process) in connection with managing physical access to the access-controlled area 104. In certain embodiments, authentication processes consistent with embodiments disclosed herein may include, without limitation, knowledge factor authentication (e.g., demonstrating knowledge of a password, a passphrase, a PIN, a challenge response, a pattern, etc.), ownership or possession factor authentication (e.g., demonstrating possession of a security and/or an identification card, a security token, a hardware token, a software token, a security key, etc.), and/or inherence and/or biometric factor authentication (e.g., providing fingerprint, retina, signature, voice, facial recognition, and/or other biometric identifiers), and/or the like.

In certain embodiments, data relating to physical access to the access-controlled area 104 may be generated and stored by the access control system 102, the domain controller 112, and/or any other associated system (e.g., stored by the domain controller 112 as audited access information 142 and/or the like). Such audited access information 142 may comprise, without limitation, information regarding which user physically accessed the access-controlled area 104, a time of such access, and/or any other information relating to such access. Among other things, audited access information 142 may be utilized in connection with comprehensive physical and cybersecurity management activities relating to the access-controlled area 104.

Although certain disclosed embodiments are illustrated as being implemented using a separate access control system 102 and/or domain controller 112, it will be appreciated that in further embodiments, some and/or all of the functions performed by the domain controller 112 and/or the access controls system 102 may be performed by a single system. For example, in some embodiments, the access control system 102 may comprise a directory service 118, a domain management module 120, an access authentication module 140, and/or audited access information 142, and/or may be configured to implement certain aspects of the disclosed systems and methods locally without direct communication with a remote domain controller 112. In certain embodiments, information may be communicated from a domain controller 112 to an access control system 102 (e.g., domain information communicated periodically, at every and/or a subset of connection events, etc.) and stored by the access control system 102 that may be used in connection with performing access authentication determinations when the access control system 102 cannot communicate with the domain controller (e.g., during an network interruption event or the like).

It will be appreciated that a number of variations can be made to the architecture and relationships presented in connection with FIG. 1 within the scope of the inventive body of work. For example, without limitation, in some embodiments, some or all of the functions performed by the access control system 102 may be performed by the domain controller 112 and/or one or more other associated systems as discussed above. In further embodiments, physical access control and resource management consistent with the disclosed embodiments may be implemented in any combination of suitable systems. Thus it will be appreciated that the architecture and relationships illustrated in FIG. 1 are provided for purposes of illustration and explanation, and not limitation.

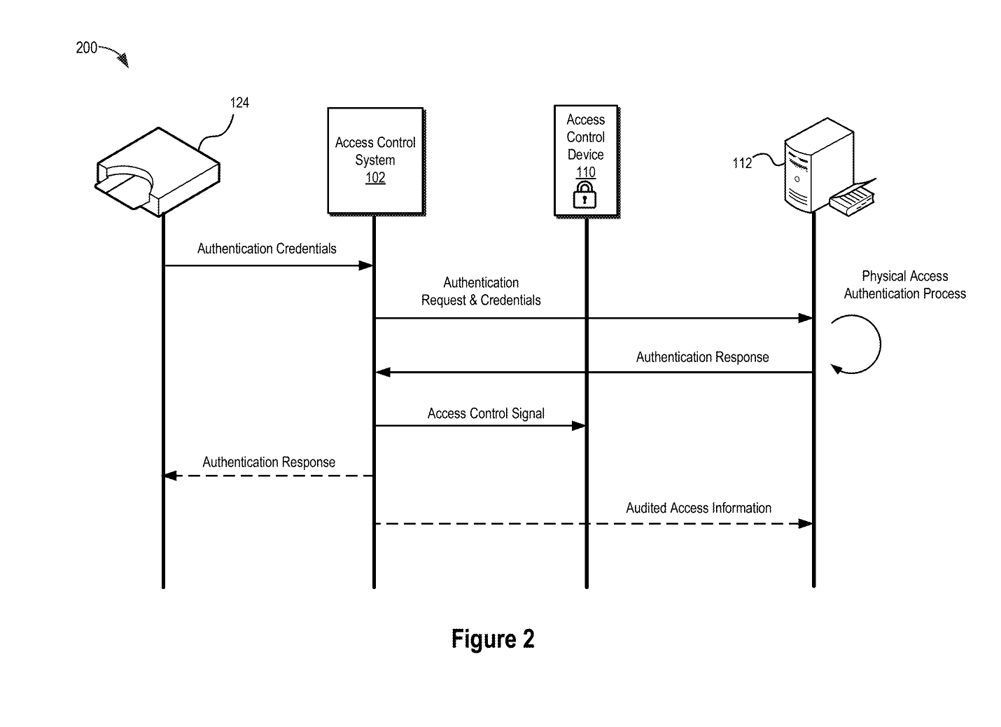

FIG. 2 illustrates a diagram 200 showing an example of a physical access management process consistent with embodiments disclosed herein. The physical access management process may be used to manage physical access to an access-controlled area using a domain controller 112. As discussed above, a physical access control interface 124, an access control system 102 associated with the access-controlled area, an access control device 110, and/or a domain controller 112 may be utilized in connection with managing physical access to an access-controlled area consistent with embodiments of the disclosed systems and methods.

To authenticate their rights to physically access an access-controlled area, a user may provide certain authentication credentials to a physical access control interface 124 associated with the access-controlled area. For example, as illustrated, a user may present an access card to a physical access control interface 124 comprising a card reader. Authentication credentials stored on the card such as a token may be read from the physical access control interface 124 and communicated to an associated access control system 102. Although illustrated in connection with a single-factor authentication process, it will be appreciated that embodiments of the disclosed systems and methods may also be used in connection with multi-factor authentication processes.

Upon receipt of the authentication credentials, the access control system 102 may communicate the credentials and an associated authentication request to a communicatively coupled domain controller 112. Among other things, the domain controller 112 may be configured to manage access to a variety of computing resources associated with one or more computing domains and physical access to the access-controlled area using, at least in part, user entry information managed by an associated directory service.

Based on the received authentication credentials and/or the authentication request, the domain controller 112 may perform a physical access authentication determination process to determine whether the authentication requested should be granted. For example, in some embodiments, the domain controller 112 may compare the received credentials with physical access attribute information included in a directory service managed by the domain controller to determine if the credentials are associated with a user having current physical access rights to the access-controlled area. Based on the results of the determination, the domain controller 112 may communicate a response to the access control system 102 indicating whether the credentials were authenticated by the service. In response, the access control system 102 may issue one or more control signals to one or more access control devices 110 configured to effectuate the access control decision.

In further embodiments, the access control system 102 may further transmit an indication of the authentication result to an interface associated with the first user (e.g., the physical access control interface 124 or the like). In some embodiments, audited access information relating to the user's interactions with the access control system 102 may be generated and/or transmitted from the access control system 102 to the domain controller 112 and/or another service.

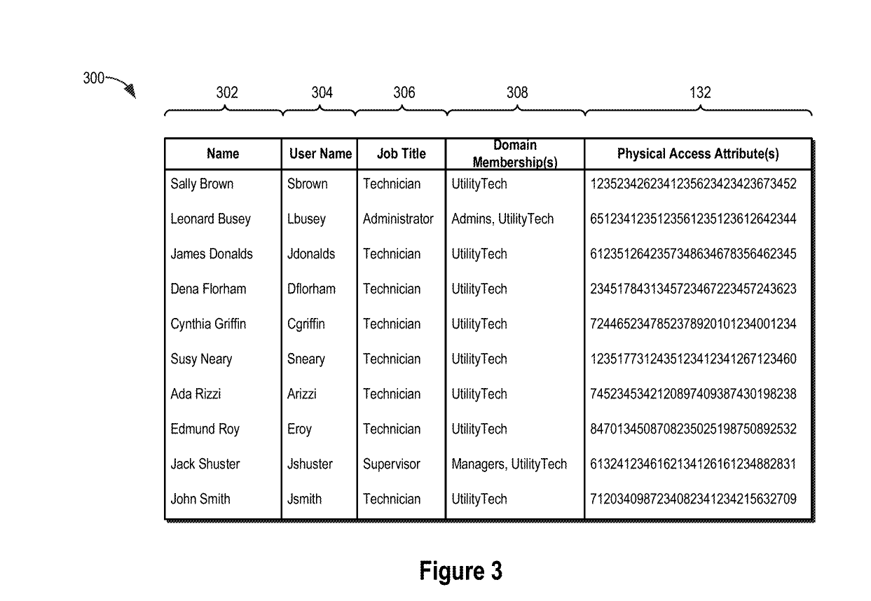

FIG. 3 illustrates an example of domain controller directory service user entries 300 including physical access attribute information 132 consistent with embodiments disclosed herein. As discussed above, in certain embodiments, a domain controller may manage a directory service that includes a database of information comprising one or more entries 300 associated with various users.

In some embodiments, information included in the directory service user entries 300 may include information that may be used in connection with managing access to a variety of computing resources associated with one or more computing domains by one or more users. In certain embodiments, the directory service user entries 300 may include information used in connection with responding to certain computing domain security authentication requests from one or more client computer systems associated with a user, authenticating and/or otherwise authorizing access to domain computing resources, and/or assigning and/or enforce access and/or security policies associated with domain resources. For example, as illustrated, the directory service user entries 300 may comprise the names of users 302, associated computing domain usernames 304, job titles and/or associated user role information 306 (e.g., user, administrator, supervisor, etc.), domain membership information 308 (e.g., administrator domains, user domains, etc.), and/or the like.

Consistent with embodiments disclosed herein, the directory service user entries 300 may further include physical access attribute information 132 used in connection with physical access request determinations performed by the domain controller and/or an associated system (e.g., an access control system or the like). In some embodiments, the physical access attribute information 132 may include physical access credentials and/or token information associated with one or more users (e.g., users 302), and may include any of the types of physical access credential information disclosed herein. For example, as illustrated, the physical access attribute information 132 may comprise alphanumeric tokens that may be stored on physical access cards issued to each user associated with the directory service user entries 300.

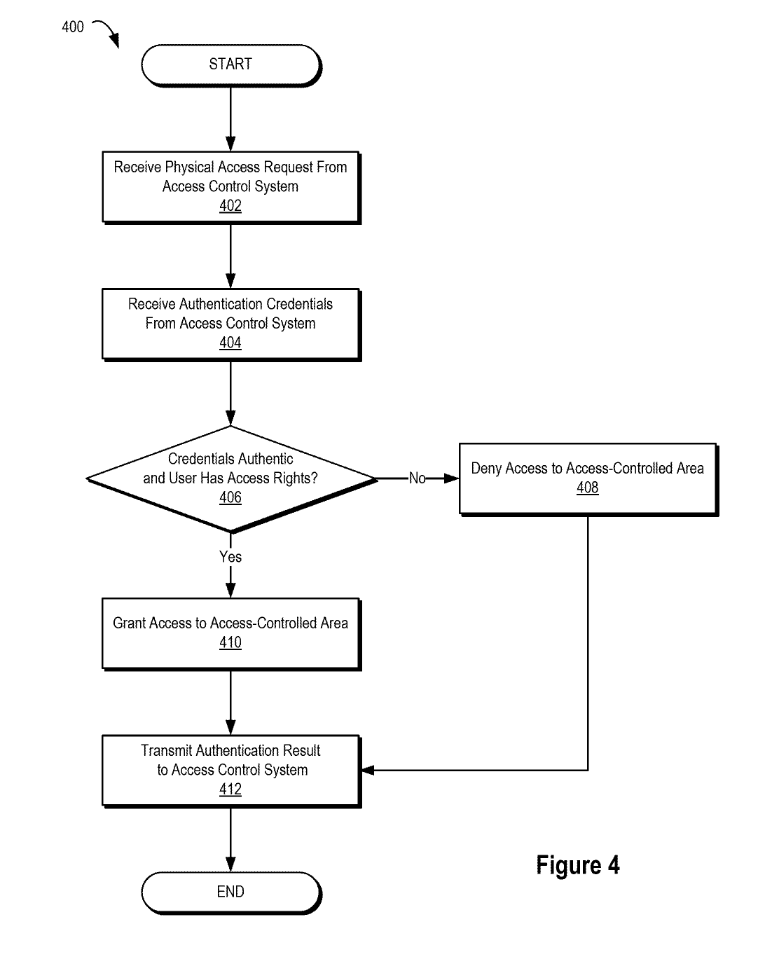

FIG. 4 illustrates a method 400 of managing physical access to an access-controlled area consistent with embodiments disclosed herein. In certain embodiments, elements of the method 400 may be performed by a domain controller. In other embodiments, elements of the method 400 may be performed by an access control system associated with an access-controlled area and/or any other suitable system and/or combination of systems.

At 402, a physical access request may be received by the domain controller from an access control system associated with an access-controlled area. In certain embodiments, the access control system may initiate the physical access request in response to a request for access and/or receipt of authentication credentials from a user wishing to gain physical access to the access-controlled-area by authenticating their physical access rights.

At 404, authentication credentials associated with the physical access request may be received by the domain controller from the access control system. In some embodiments, the authentication credentials, which may comprise any of the types of authentication credentials disclosed herein, may be provided to the access control system using a physical access control interface (e.g., a card reader or the like) associated with the access control system.

A determination may be made at 406 regarding whether the authentication credentials are associated with a user having current physical access rights to the access-controlled area and/or whether the credentials satisfy other authentication requirements (e.g., whether a plurality of types of authentication credentials are provided to satisfy a two-factor authentication requirement, whether particular types of required authentication credentials are provided, and/or the like). In certain embodiments, the determination may utilize physical access attribute information included in an associated entry of a directory service managed by the domain controller.

If it is determined at 406 that the authentication credentials are associated with a user having current physical access rights to the access-controlled area and that the credentials satisfy other authentication requirements, the method 400 may proceed to 410 and 412, where physical access to the access-controlled area may be granted and an associated authentication result may be transmitted to the access control system which may implement the access control decision. (e.g., by generating one or more control signals effectuating the grant of access and/or the like). Otherwise, the method 400 may proceed to 408 and 410, where physical access to the access-controlled area may be denied to the requesting user and an associated authentication result may be transmitted to the access control system for implementation.

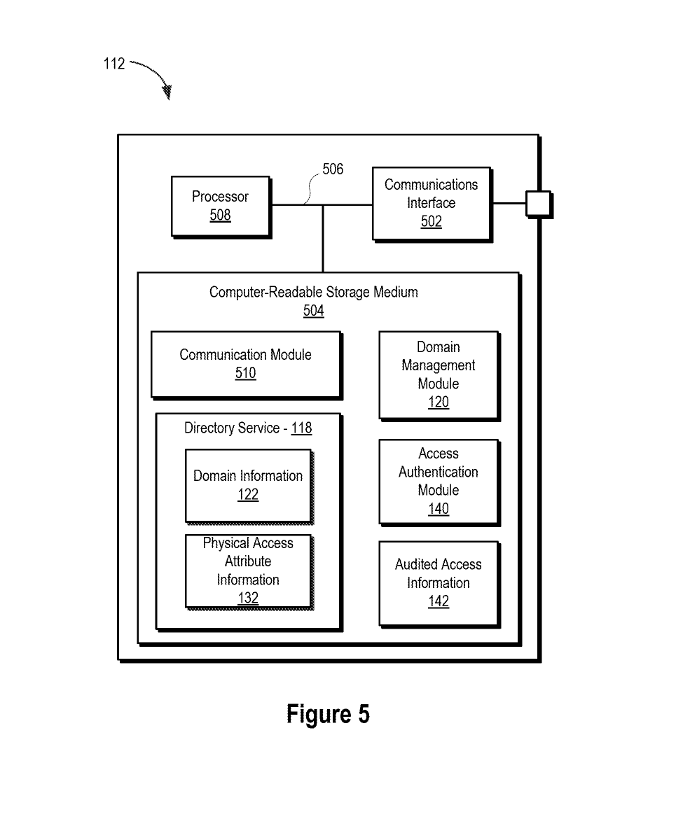

FIG. 5 illustrates a functional block diagram of a domain controller 112 configured to manage one or more resources consistent with embodiments disclosed herein. Embodiments of the domain controller 112 may be utilized to implement embodiments of the systems and methods disclosed herein. For example, the domain controller 112 may be configured to interact with an access control system in connection with managing physical access to an access-controlled area.

The domain controller 112 may include a communications interface 502 configured to communicate with a communication network. In certain embodiments, the communications interface 502 may comprise a wired and/or wireless communication interface configured to facilitate communication with a network, other systems and/or devices, and/or mobile devices. For example, in some embodiments, the domain controller 112 may be configured to securely communicate with an access control system in connection with receiving authentication requests and associated credentials, to communicate authentication responses to the access control system, to receive associated audited access information 142 from the access control system, and/or the like.

A computer-readable storage medium 504 may be the repository of one or more modules and/or executable instructions configured to implement any of the processes described herein. A data bus 506 may link the communications interface 502, and the computer-readable storage medium 504 to a processor 508. The processor 508 may be configured to process communications received via the communications interface 502. The processor 508 may operate using any number of processing rates and architectures. The processor 508 may be configured to perform various algorithms and calculations described herein using computer executable instructions stored on computer-readable storage medium 504.

The computer-readable storage medium 504 may be the repository of one or more modules and/or executable instructions configured to implement certain functions and/or methods described herein. For example, the computer-readable storage medium 504 may include one or more access authentication modules 140 configured to perform embodiments of the physical access authentication methods disclosed herein and/or one or more domain management modules 120 configured to perform certain domain management and/or domain resource management activities. The computer-readable medium 504 may further include a communication module 510, a directory service 118, and/or audited access information 142.

The access authentication module 140 may perform physical access authentication processes consistent with embodiments disclosed herein. For example, as discussed above, in certain embodiments, the access authentication module 120 may determine whether a user requesting access to an access-controlled area has current rights to the physical access the area. Consistent with the disclosed embodiments, the access authentication module 120 may utilize domain information 122 and/or physical access attribute information 132 included in a directory service 118 managed by the domain controller 112 in connection with authenticating physical access to a user.

A communication module 510 may include instructions for facilitating communication of information from the domain controller 112 to other controllers, systems, devices (e.g., access control devices), resources, transient assets and/or other components in the electric power delivery system and/or a distributed site associated with the same. The communication module 510 may include instructions on the formatting of communications according to a predetermined protocol. In certain embodiments, the communication module 510 may be configured to issue one or more control signals to associated access control systems configured to effectuate a particular access control decision. The communication module 510 may be configured with subscribers to certain information, and may format message headers according to such subscription information.

While specific embodiments and applications of the disclosure have been illustrated and described, it is to be understood that the disclosure is not limited to the precise configurations and components disclosed herein. For example, the systems and methods described herein may be applied to a variety of distributed sites of an electric power generation and delivery system. It will further be appreciated that embodiments of the disclosed systems and methods may be utilized in connection with a variety of systems, devices, and/or applications utilizing physical access control systems and methods, and/or applications that are not associated with and/or are otherwise included in an electric power delivery system. Accordingly, many changes may be made to the details of the above-described embodiments without departing from the underlying principles of this disclosure. The scope of the present invention should, therefore, be determined only by the following claims.

What is claimed is:

1. A domain controller configured to manage physical access to an access-controlled area of a distributed site of an electric power delivery system, the system comprising:
a communications interface configured to receive a physical access authentication request and authentication credentials from a communicatively coupled access control system associated with the access-controlled area;
a processor communicatively coupled to the communications interface; and
a computer-readable storage medium communicatively coupled to the processor and the communications interface, the computer-readable storage medium storing instructions that, when executed by the processor, cause the processor to:
identify, based on the physical access authentication request, physical access attribute information associated with a user entry included in a directory service managed by the domain controller, the directory service being stored on the computer-readable storage medium;
determine, based on the physical access attribute information, whether the authentication credentials are associated with an individual having current access rights to the access-controlled area;
generate, based on the determination, an authentication response indicating whether the authentication credentials are associated with an individual having current access rights to the access-controlled area; and
transmit, using the communications interface, the authentication response to the access control system.

2. The domain controller of claim 1, wherein the authentication credentials comprise at least one of a personal identification number, a password, a passphrase, a response to a challenge, a pattern, information stored on a card, information stored on a security token, information stored on a hardware token, information stored on a software token, and biometric identification information.

3. The domain controller of claim 1, wherein the physical access attribute information comprises at least one credential issued to a user.

4. The domain controller of claim 3, wherein the physical access attribute information further comprises at least one of a personal identification number, a password, a passphrase, a response to a challenge, a pattern, information stored on a card, information stored on a security token, information stored on a hardware token, information stored on a software token, and biometric identification information.

5. The domain controller of claim 1, wherein determining whether the authentication credentials are associated with an individual having current access rights to the access-controlled area comprises:
comparing the authentication credentials with the physical access attribute information; and
determining that the received authentication credentials match the physical access attribute information.

6. The domain controller of claim 1, wherein the authentication response is configured to cause the access control system to generate an access control signal configured to cause an access control device to actuate a lock associated with the access-controlled area.

7. The domain controller of claim 1, wherein the authentication response is configured to cause the access control system to generate an access control signal configured to cause the access control device to change a status of an alarm system associated with the access-controlled area.

8. The domain controller of claim 1, wherein the directory service further comprises access rights information associating the user entry with computing resources including in at least one computing domain managed by the domain controller.

9. An access control system associated with an access-controlled area of a distributed site of an electric power delivery system, the system comprising:
a credential input interface configured to receive authentication credentials from a user;
a communications interface communicatively coupled to an access control device associated with the access-controlled area and a domain controller associated with the access control system, the domain controller managing a directory service comprising a plurality of user entries, each user entry of the plurality of user entries comprising physical access attribute information;
a processor communicatively coupled to the credential input interface and the communications interface;
a computer-readable storage medium communicatively coupled to the processor, the computer-readable storage medium storing instructions that, when executed by the processor, cause the processor to:
generate, based on the received authentication credentials, a physical access authentication request;
transmit, via the communications interface, the physical access authentication request and the authentication credentials to the domain controller;
receive, from the domain controller, an authentication response, the authentication response being generated by the domain controller based on a comparison of the authentication credentials with the physical access attribute information included in the directory service;
generate, based on the authentication response, an access control signal configured to implement an access control action by the access control device allowing the user physical access to the access-controlled area; and
transmit, via the communications interface, the access control signal to the access control device.

10. The access control system of claim 9, wherein the authentication credentials comprise at least one of a personal identification number, a password, a passphrase, a response to a challenge, a pattern, information stored on a card, information stored on a security token, information stored on a hardware token, information stored on a software token, and biometric identification information.

11. The access control system of claim 9, wherein the access control signal is configured to cause the access control device to actuate a lock associated with the access-controlled area.

12. The access control system of claim 9, wherein the access control signal is configured to cause the access control device to change a status of an alarm system associated with the access-controlled area.

13. A method performed by a domain controller for managing physical access to an access-controlled area of a distributed site of an electric power delivery system, the method comprising:
receiving a physical access authentication request and authentication credentials provided by a user from a communicatively coupled access control system associated with the access-controlled area;
identifying, based on the physical access authentication request, physical access attribute information associated with a user entry included in a directory service managed by the domain controller;
determining, based on the physical access attribute information, whether the authentication credentials are associated with an individual having current access rights to the access-controlled area;
generating, based on the determination, an authentication response indicating whether the authentication credentials are associated with an individual having current access rights to the access-controlled area; and
transmitting the authentication response to the access control system.

14. The method of claim 13, wherein the authentication credentials comprise at least one of a personal identification number, a password, a passphrase, a response to a challenge, a pattern, information stored on a card, information stored on a security token, information stored on a hardware token, information stored on a software token, and biometric identification information.

15. The method of claim 13, wherein the physical access attribute information comprises at least one credential issued to a user.

17. The method of claim 15, wherein the physical access attribute information further comprises at least one of a personal identification number, a password, a passphrase, a response to a challenge, a pattern, information stored on a card, information stored on a security token, information stored on a hardware token, information stored on a software token, and biometric identification information.

17. The method of claim 13, wherein determining whether the authentication credentials are associated with an individual having current access rights to the access-controlled area comprises:
comparing the authentication credentials with the physical access attribute information; and
determining that the received authentication credentials match the physical access attribute information.

18. The method of claim 13, wherein the authentication response is configured to cause the access control system to generate an access control signal configured to cause an access control device to actuate a lock associated with the access-controlled area.

19. The method of claim 13, wherein the authentication response is configured to cause the access control system to generate an access control signal configured to cause the access control device to change a status of an alarm system associated with the access-controlled area.

20. The method of claim 12, wherein the method further comprises:
generating, based on the authentication response, audited access information regarding access to the access-controlled area by the user.
